(19) United States
(12) Patent Application Publication
(10) Pub. No.: US 2018/0228102 A1
(43) Pub. Date: Aug. 16, 2018

(54) WATER CONTAINMENT APPARATUS FOR PLANTS

(71) Applicant: Carie Centeno, Shadow Hills, CA (US)

(72) Inventor: Carie Centeno, Shadow Hills, CA (US)

(21) Appl. No.: 15/894,088

(22) Filed: Feb. 12, 2018

Related U.S. Application Data
(60) Provisional application No. 62/457,611, filed on Feb. 10, 2017.

(51) Int. Cl. A01G 27/02

(52) U.S. Cl. CPC A01G 27/02

(57) ABSTRACT

A movable, sizeable, decorative, flexible, plant watering containment apparatus. The water containment provides a direct watering solution for sparse, desert and sloped landscaping. Eliminates water run off with no placement restrictions and sizeable via the cooperative engagement of one or more panels to fit any plant.

### CROSS-REFERENCE TO RELATED APPLICATION

This application claims the benefit of priority of U.S. provisional application No. 62/457,611, filed Feb. 10, 2017, the contents of which are herein incorporated by reference.

### BACKGROUND OF THE INVENTION

The present invention relates to direct watering of plants, and more particularly, apparatus to contain water applied to a plant.

Presently in the art, there can be excessive water run off using direct watering techniques, such as drip systems, hoses, sprinklers and with hand watering of plants, such as used in landscaping around a home, or in a home garden. The runoff is more pronounced in drought stricken areas, sloped terrain and more particularly for drought tolerant landscaping in desert and dry environments. This water run off can lead to excessive water consumption, repeated watering treatments, and risk to the plant receiving sufficient hydration.

Drip watering systems are generally permanently installed and are difficult to move as plants grow. Other drip watering systems are readily moved and may get inadvertently displaced, causing unnecessary watering.

As can be seen, there is a need for an improved water containment apparatus for properly hydrating plants and landscaping to eliminate water runoff.

### SUMMARY OF THE INVENTION

In one aspect of the present invention, a panel for forming a water containment apparatus for the watering of plants is disclosed. The panel includes a substantially rectangular sheet of material having a protruding lip extending along the panel such that a top end of the panel is forwardly offset from a bottom end of the panel along a front surface of the panel. A protruding tab is defined at a first end of the panel and extends from the bottom end of the panel. A hole is defined at a second end of the panel. The hole may be dimensioned to receive the protruding tab in a snap fit configuration.

In other aspects of the invention, a water containment apparatus for the watering of plants includes a panel formed as a substantially rectangular sheet of material having a protruding lip extending along the panel such that a top end of the panel is forwardly offset from a bottom end of the panel along a front surface of the panel. A protruding tab is defined at a first end of the panel and extends from the bottom end of the panel. A hole is defined at a second end of the panel, wherein the hole is dimensioned to receive the protruding tab in a snap fit configuration. In some embodiments, the tab is received in the hole to form the panel as a generally cylindrical containment apparatus.

In other embodiments, the water containment apparatus may include a plurality of panels, wherein a tab of a first panel is received in the hole of a subsequent panel. A tab of the subsequent panel is received in a hole of the first panel; and the first panel and the subsequent panel are formed as a generally cylindrical containment apparatus having a top opening and a bottom opening.

In other embodiments, the tab of the subsequent panel is received in the hole of a last panel, and a tab of the last panel is received in the hole of the first panel to define the containment apparatus.

Yet other aspects of the invention include a method of containing water for watering the root bulb of a plant. The method includes providing one or more panels formed as a substantially rectangular sheet of material having a protruding lip extending along the panel such that a top end of the panel is forwardly offset from a bottom end of the panel along a front surface of the panel, a protruding tab is defined at a first end of the panel and extends from the bottom end of the panel, and a hole is defined at a second end of the panel, wherein the hole is dimensioned to receive the protruding tab in a snap fit configuration.

One or more panels may be joined by interconnecting the tab and the hole to form a generally cylindrical water containment apparatus having a top opening and a bottom opening. The bottom opening of the containment apparatus is placed on a ground surface above the root bulb of the plant. In some embodiments, the bottom end of the containment apparatus may be partially embedded in the soil surrounding the plant. Water may then be delivered through the top opening to water the root bulb of the plant. Once complete, the water containment apparatus may be removed from around the plant.

These and other features, aspects and advantages of the present invention will become better understood with reference to the following drawings, description and claims.

### BRIEF DESCRIPTION OF THE DRAWINGS

FIG. 1a is a front elevation view of a water containment panel.

FIG. 1b is a side end view of the water containment panel.

FIG. 2 is a perspective view of a water containment apparatus formed by a plurality of panels.

FIG. 3 is a perspective view of a water containment apparatus formed by a single panel.

FIG. 4 is a perspective view of the water containment panel.

FIG. 5 is a perspective view of a plurality of panels oriented to form a water containment apparatus.

FIG. 6 is a perspective view of a plurality of panels joined.

FIG. 7 is a perspective view of the plurality of joined panels formed as a water containment apparatus that is placed on the ground surface around a root ball of a plant.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a water containment apparatus that is configured to be positioned around a plant to contain and substantially reduce water run off during direct watering applications.

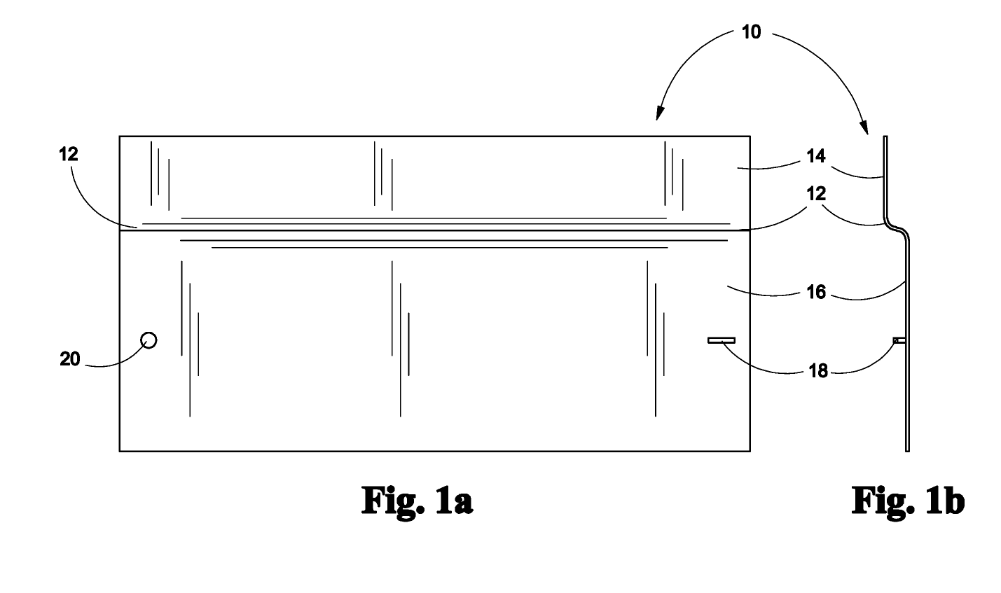

As seen in reference to FIGS. 1 and 1b, a water containment panel 10 of the present invention is illustrated. The panel 10 is formed of a substantially rectangular shaped flat, flexible material that may be formed with a protruding lip 12 along its longitudinal length such that a top edge 14 of the panel 10 is offset from a bottom portion 16 of the panel 10 along its vertical face. The dimensions of the panel 10 may be any desired length or width, though panels of about a 12″×6″ are preferable to obtain the desired depth for containment of water and provide sufficient length to encircle a variety of plants.

The panel 10 includes a male protrusion 18, or tab, at a first end of the panel 10 and an open hole 20, or slot, at a second end of the panel 19, the open hole 20 being dimensioned to receive the male protrusion 18 therein. The protrusion 18 may be configured with a flared peripheral edge that is dimensioned for a snap fitting cooperative engagement with the open hole 20. The panel may further include a lip 12 forming the offset portion 14 extending longitudinally along a length of the panel at a top edge thereof.

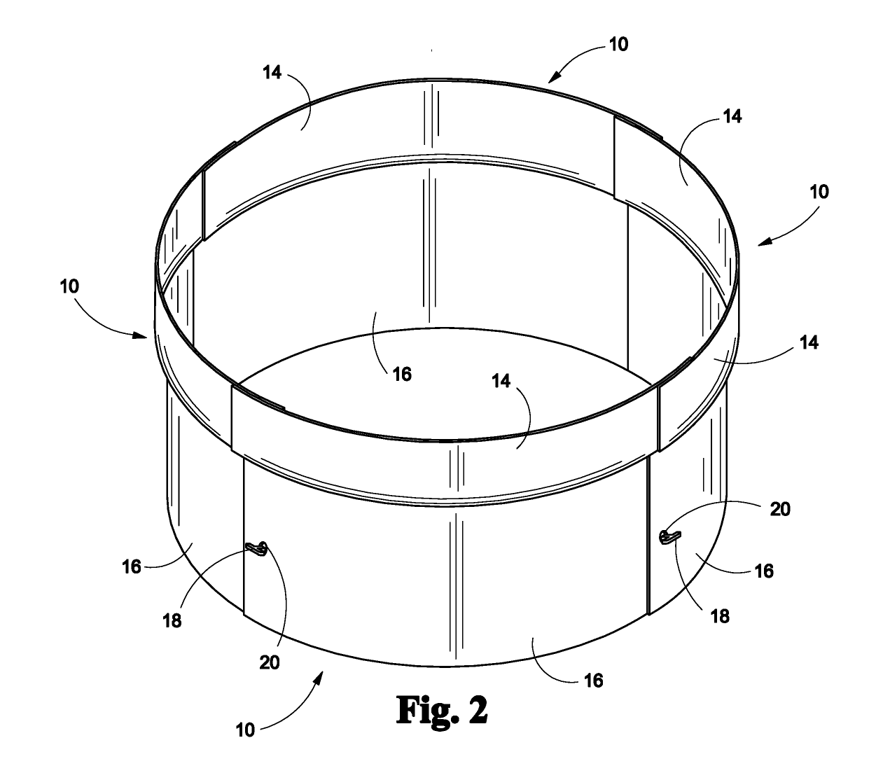

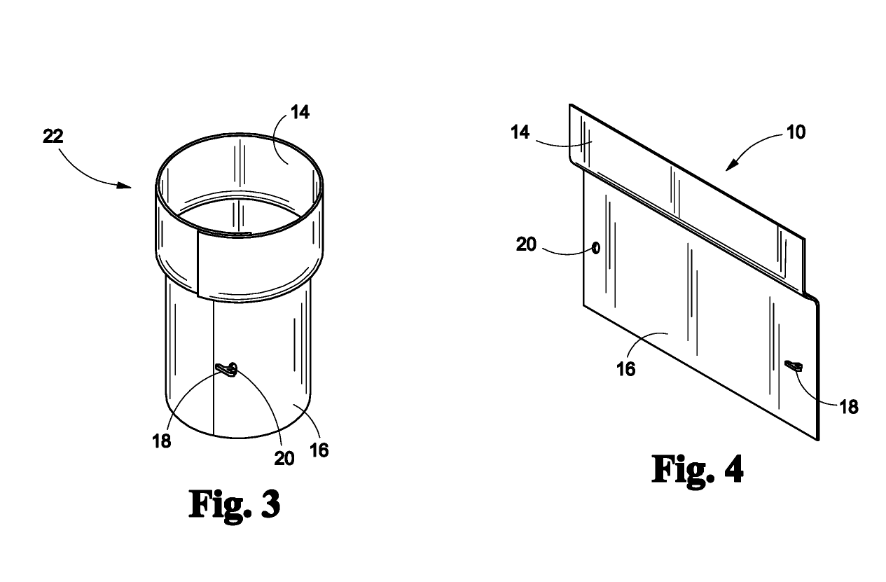

As seen in reference to FIGS. 2, 3, 7 and the water containment panel 10 may be formed in a substantially circular arrangement, with the male protrusion 18 and the open hole 20 engaged to form a ring like containment apparatus to place around the plant. In the embodiment shown in FIG. 2, two panels 10 are joined to form the containment apparatus. In the embodiment shown in FIG. 3, a single panel 10 is joined to form the water containment apparatus. Any number of water containment panels 10 may be joined to form a containment apparatus of a desired dimensions to surround the plant.

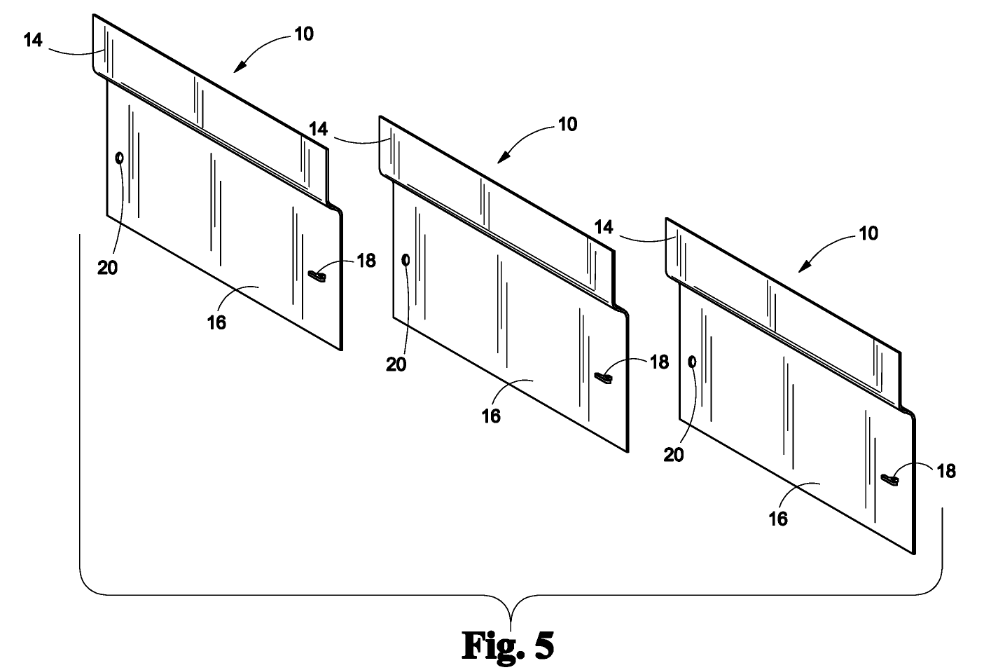

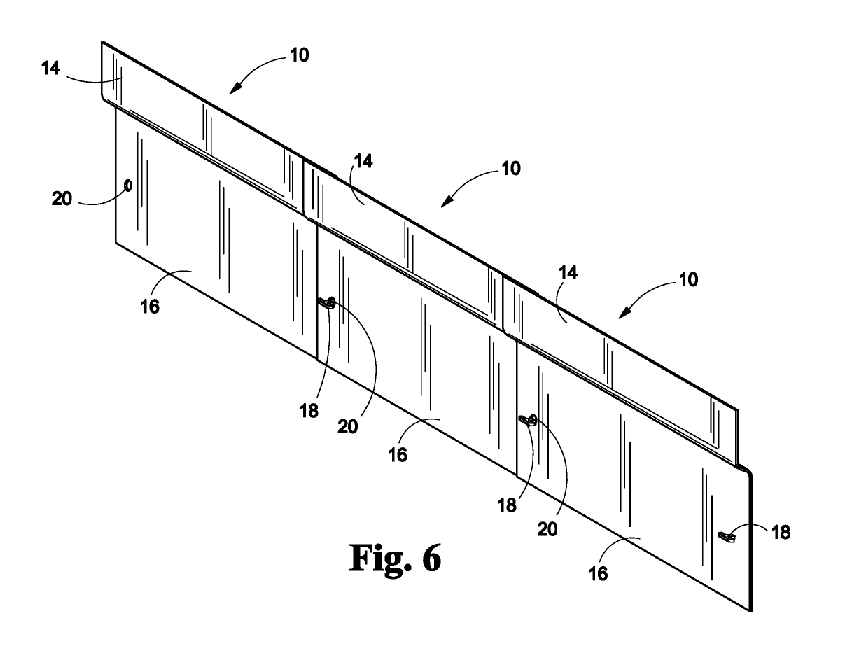

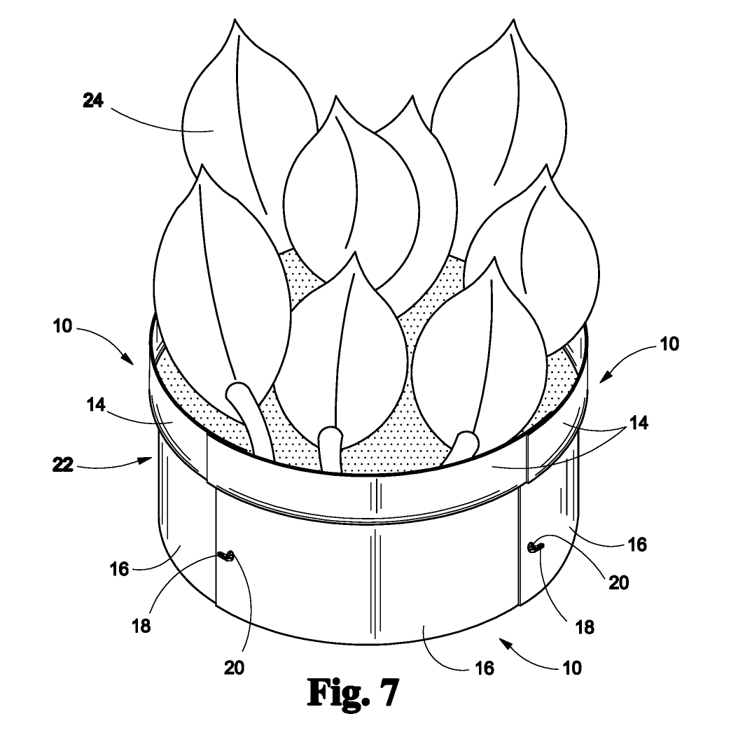

The assembly of a plurality of water containment panels 10 is shown in reference to FIGS. 5 and 6. The selected number of panels 10 may be placed in an organized manner and oriented in the same direction. The tabs 18 of a preceding panel 10 are joined with the open hole 20 of a successive panel 10 and joined by the cooperative engagement of the tab 18 with the hole 20. The selected number of panels 10 are joined and then the tab 18 of the last panel is joined with the open hole 20 of the first panel.

As seen in reference to FIG. 7, the joined panels 10 forming the water containment apparatus 22 may then be placed to surround the periphery of the plant 24. The apparatus 22 may be formed in a generally circular pattern or may be formed in a desired irregular shape forming at least one sidewall around the plant 24. Depending on the surface soil conditions around the base of the plant 24, the containment apparatus 22 may need to be urged downwardly to engage the bottom edge of the apparatus with the soil surface around the plant so that water is contained within the sidewall of the apparatus and carried towards the root structure of the plant. In some circumstances, it may be necessary to dig the soil surface in order for the bottom edge 16 of the apparatus 22 to be engaged in the soil. Pins or stakes may be used to secure the containment apparatus 22 in the soil, preferably having a hook or similar structure to hold down the top edge 14 of the sidewall of the apparatus.

In use, the user would surround the base of a plant 24 with a single panel 10 or multiple panels 10 and the bottom edge 16 placed firmly on the ground. The panel 10 or panels may then be locked together and secured with stakes or spikes. The user may then fill the interior of the containment apparatus 22 with water. Once the water seeps into the ground, the user may refill with more water to keep the plants properly hydrated. The apparatus 22 may be left in place or conveniently relocated to another plant 7 or plant grouping. The surrounding sidewall of the water containment apparatus 22 ensures that the majority of the water is directed downwardly to the root structure, rather than running off the soil surface.

It should be understood, of course, that the foregoing relates to exemplary embodiments of the invention and that modifications may be made without departing from the spirit and scope of the invention as set forth in the following claims.

What is claimed is:

1. A panel for forming a water containment apparatus for the watering of plants, comprising:
a substantially rectangular sheet of material having a protruding lip extending along the panel such that a top end of the panel is forwardly offset from a bottom end of the panel along a front surface of the panel;
a protruding tab defined at a first end of the panel and extending from the bottom end of the panel, and
a hole defined at a second end of the panel.

2. The panel of claim 1, wherein the hole is dimensioned to receive the protruding tab in a snap fit configuration.

3. A water containment apparatus for the watering of plants, comprising:
a panel formed as a substantially rectangular sheet of material having a protruding lip extending along the panel such that a top end of the panel is forwardly offset from a bottom end of the panel along a front surface of the panel;
a protruding tab defined at a first end of the panel and extending from the bottom end of the panel, and
a hole defined at a second end of the panel, wherein the hole is dimensioned to receive the protruding tab in a snap fit configuration.

4. The water containment apparatus of claim 1, wherein the tab is received in the hole to form the panel as a generally cylindrical containment apparatus.

5. The water containment apparatus of claim 1; further comprising:
a plurality of panels, wherein a tab of a first panel is received in the hole of a subsequent panel.

6. The water containment apparatus of claim 5, wherein a tab of the subsequent panel is received in a hole of the first panel; and the first panel and the subsequent panel are formed as a generally cylindrical containment apparatus having a top opening and a bottom opening.

7. The water containment apparatus of claim 5, wherein the tab of the subsequent panel is received in the hole of a last panel is received, and a tab of the last panel is received in the hole of the first panel.

8. A method of containing water for watering the root bulb of a plant, comprising:
providing one or more panels formed as a substantially rectangular sheet of material having a protruding lip extending along the panel such that a top end of the panel is forwardly offset from a bottom end of the panel along a front surface of the panel, a protruding tab defined at a first end of the panel and extending from the bottom end of the panel, and a hole defined at a second end of the panel, wherein the hole is dimensioned to receive the protruding tab in a snap fit configuration;
joining the one or more panels by interconnecting the tab and the hole to form a generally cylindrical water containment apparatus having a top opening and a bottom opening.

9. The method of claim 8, further comprising:
placing a bottom opening on a ground surface above the root bulb of the plant.

10. The method of claim 8, further comprising:
embedding the bottom end of the containment apparatus in the soil surrounding the plant.

11. The method of claim 9, further comprising:
delivering water through the top opening to water the root bulb of the plant.

12. The method of claim 11
removing the water containment apparatus from around the plant.
